(19) United States
(12) Patent Application Publication
(10) Pub. No.: US 2016/0132050 A1
(43) Pub. Date: May 12, 2016

(54) ASSEMBLY FOR ESTIMATING THE SERVICE LIFE OF AN ELECTRIC MOTOR

(71) Applicant: EBM-PAPST ST. GEORGEN GMBH & CO. KG, St. Georgen (DE)

(72) Inventors: Frank Heller, KOENIGSFELD-BURGBERG (DE); Mojtaba Moini, TUEBINGEN (DE)

(73) Assignee: EBM-PAPST ST. GEORGEN GmbH & Co. KG, ST. GEORGEN (DE)

(21) Appl. No.: 14/894,995

(22) PCT Filed: Jun. 27, 2014
(86) PCT No.: PCT/EP2014/063773

§ 371 Date: Dec. 1, 2015

(30) Foreign Application Priority Data
Jun. 29, 2013 (DE) 10 2013 106 838.3

(51) Int. Cl. G05B 23/02; H02P 6/12

(52) U.S. Cl. CPC G05B 23/0224; H02P 6/12

(57) ABSTRACT

An electronically commutated motor (32) has, associated with it, a circuit board (36) having arranged thereon a temperature sensor for generating a temperature signal. Provided are: A first arrangement for continuous determination of the prospectively still-available service life of the motor (32); a second arrangement (20, 236) for sensing a first value that is dependent on the temperature signal (33) and that characterizes the temperature (T_S) adjacent the circuit board (36); a third arrangement (240; 244) for sensing a rotation speed (n) of the motor (32); a memory (31) for storing a digital third value (Cr) for the prospectively still available service life of the motor (32); a calculation apparatus (30) which calculates an estimated still-available service life and an output apparatus (83) for the results. A current service life correction value (Δt) is preferably also generated as a function of the electrical power and/or of the current and voltage.

### CROSS-REFERENCE TO RELATED APPLICATIONS

This application is a section 371 of PCT/EP2014/063773 published as WO 2014-207242-A and further claims priority from German 10 2013 106 838.3 filed 2013 Jun. 29, the contents of which are incorporated by reference.

### FIELD OF THE INVENTION

The invention relates to an electronically commutated motor having an arrangement for continuously determining the prospectively still available service life of the motor. A motor of this kind can, for example, drive a miniature motor or a fan. Such motors nowadays are almost exclusively implemented as so-called “brushless” or (equivalently) “electronically commutated” motors, and the present invention is also preferably utilized in the context of brushless electric motors.

### BACKGROUND

The manufacturers of such electric motors determine for them, by experiment, an average service life that is indicated in catalogs. According to the catalog, for example, an axial fan of the Applicant, model 612NMI, has a prospective life expectancy of 80,000 hours at 40° C. and when the rotor is journaled with ball bearings. At the maximum permissible operating temperature of 65° C., conversely, the prospective life expectancy is only 45,000 hours. This is the consequence principally of the fact that the ball bearings have a shorter service life with increasing temperature. The bearings are thus usually the component that limits service life, and the service life of the bearings depends significantly on the temperature of the bearings.

Catalog information of this kind is helpful, but the temperature changes, for example, with the seasons and with solar input, and can also change in the course of a day.

When a fan is to be used for a mobile radio station on a mountain or on a tower, where the fan can be replaced only at considerable cost in the event of a defect, it is economically sensible to use a fan having a very long service life and to replace it in timely fashion, in good weather, in order to minimize costs resulting from a failure.

In most cases the cost for a new fan plays no part, but the operator of a mobile radio network is interested in knowing the prospective magnitude of the average or remaining life expectancy of the fans being used.

An accurate prediction is impossible, however, since a fan, for example, may have experienced bearing damage during transport or installation and then has a shorter service life. Like all predictions, predictions about the service life of a fan are subject to considerable uncertainty; but they are still valuable, since conclusions as to the quality of the fan in question, and its prospective service life, can be drawn from the manner in which the expected service life changes over time.

Predictions are difficult because fans of this kind must work in very different operating conditions, for example heat or cold, clean or dirty air, bearing type (plain or ball bearings), type of bearing lubrication, type of lubricating grease used, fan operation in a humid or dry atmosphere, different rotation speeds (e.g. fast during the heat of summer and very slowly, or even stopped, in the depth of winter), dusty or clean air, etc.

### SUMMARY OF THE INVENTION

An object of the present invention is therefore to make available a novel arrangement of the kind recited initially.

This object is achieved according to the invention by equipping an electronically commutated motor with a circuit board, a temperature sensor, rotation-speed detection means, and optionally sensors for other ambient environmental conditions, and calculating means for periodically estimating a remaining available service life, and for outputting the calculation result, so that appropriate service action can be taken before failure occurs.

Because the operating conditions of an electric motor are continuously taken into account in the predictive calculation of the service life still to be expected, it is also possible to visualize “service life reserves” that occur, for example, because in cold seasons a fan experiences little stress since it can then run at a lower rotation speed, if its rotation speed is regulated as a function of ambient temperature.

Further details and advantageous refinements of the invention are evident from the exemplifying embodiments, in no way to be understood as a limitation of the invention, that are described below and depicted in the drawings.

### BRIEF FIGURE DESCRIPTION

FIG. 1 is an overview diagram of the fundamental configuration of an arrangement according to the present invention;

FIG. 2 shows a simple circuit for sensing a temperature in the motor;

FIG. 3 schematically depicts the value acquisition function;

FIG. 4 is a flow chart that explains how the prospective life expectancy is continuously corrected during operation;

FIG. 5 is a graphical depiction to explain FIG. 4;

FIG. 6 is a depiction to explain the correction value Δt,

FIG. 7 shows the output of a TL1 signal and TL2 signal that respectively contain information about the rotation speed and service life;

FIG. 8 shows the output of an AL1 signal that contains information both about a fan alarm and about service life;

FIG. 9 shows a fan having an arrangement according to the present invention; and

FIG. 10 is an overview diagram regarding a modified exemplifying embodiment of the arrangement according to the present invention of FIG. 1.

### DETAILED DESCRIPTION

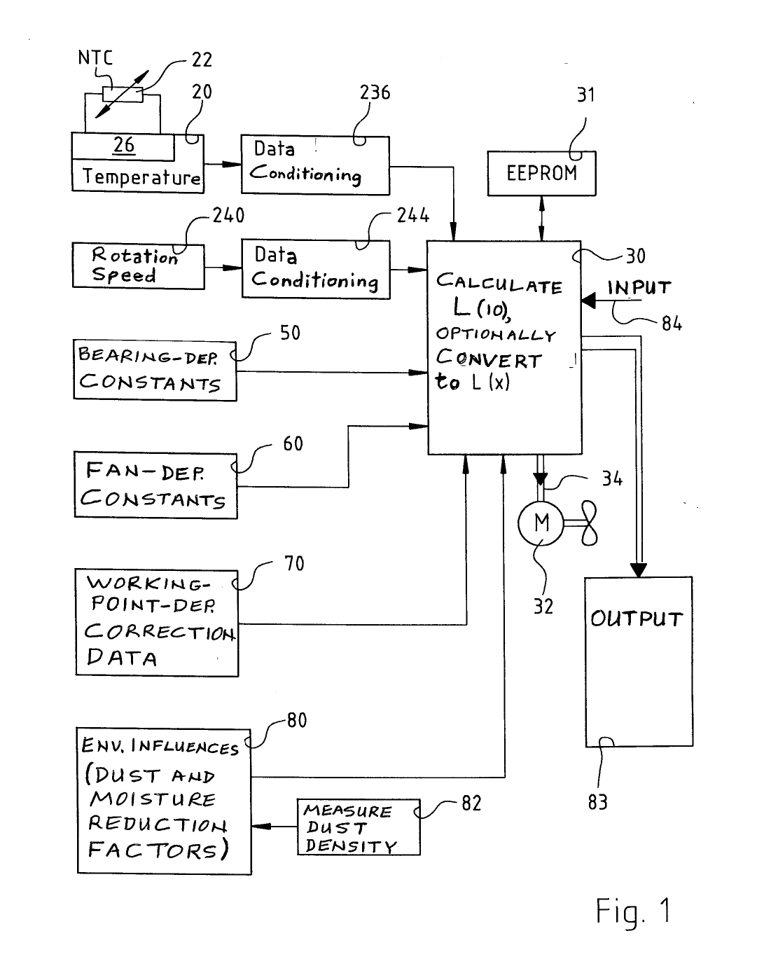

FIG. 1 schematically shows preferred components that are incorporated into the predictive calculation of the remaining service life of an electric motor.

Manufacturers' catalogs usually indicate the L10 value, e.g. “L10=60,000 hours.” This means that under specific operating conditions, e.g. an ambient temperature of 40° C., ten fans out of 100 fans will fail within a period of 60,000 hours.

“L1=30,000 hours” analogously means that under these operating conditions, only one motor out of 100 motors will fail within 30,000 hours.

The values for L10 can be converted into values for L1 and vice versa, the values for L1 of course being lower than the values for L10.

For important drive systems, e.g. cooling a telephone station on a church steeple or a pump in a medical device, L1 is usually taken as the basis; and for less critical drive systems, e.g. for fans in batteries of fans where quick replacement of a defective fan is possible, the usual basis is L10, i.e. in this case more failures are tolerated. All other things being equal, it can be assumed as a general rule that service life is halved for a temperature increase of 10 K (K=Kelvin=indicator of temperature change).

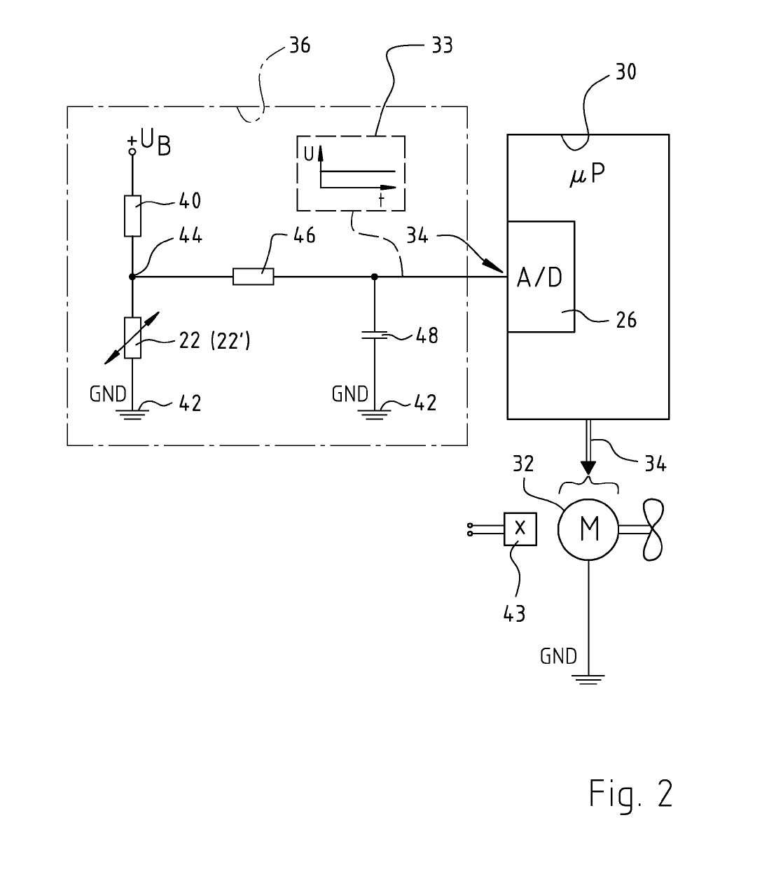

FIG. 1 schematically shows, at 20, the sensing of a temperature of a monitored motor 32 (FIG. 2) using an A/D converter 26. What is significant for calculating the remaining service life is principally the temperature profile (Temp.) of the bearings of this motor. The change in motor rotation speed n over time can, however, also play a part.

The service life of bearings is often quoted by bearing manufacturers as a function of the temperature at the bearings. For a bearing model used by the Applicant, for example, the service life can be indicated approximately as follows:

At a bearing temperature of 32° C. or less the service life is X hours, where X hours corresponds to the maximum service life, e.g. 80,000 hours.

Above 32° C. the service life is halved for each 30 K. In other words, the higher the temperature at the bearings, the greater the service life correction value must be for a given predetermined time period. At 62° C., for example, the service is life X/2 hours, i.e. half the maximum service life X; and at 92° C. it is X/4 hours, i.e. a quarter of the maximum service life X.

The service life correction value is therefore, for example, doubled at a temperature of 62° C. for a predetermined time period as compared with a temperature of 32° C. for a predetermined time period since, so to speak, more of the remaining service life, or of the remaining service life “credit,” is consumed.

The service life in a fan taken as an example can be indicated, for example, as follows:

L10(T_L)=L10(70° C.)*2̂((70° C.−T_L)/20).

Here T_L corresponds to the temperature at the bearing, and at a temperature T_L<30° it is assumed that T_L=30° C., i.e. minimum wear. For temperatures T_L>70° C. a more severe shortening of service life can occur if, for example, the bearing grease used is not heat-resistant above that temperature. The value L10 (70° C.) can be determined, for example, from data from the bearing manufacturer; it usually depends on the bearing grease used, on the bearing biasing that is selected, and on the maximum expected imbalance of the rotor.

The formula yields, for example:

L10(30° C.)=L10(70° C.)*2̂2=4*L10(70° C.)

L10(50° C.)=L10(70° C.)*2̂1=2*L10(70° C.)

The service life correction value must correspondingly be selected to be lower at lower temperatures and higher at higher temperatures, in order to adapt or determine the remaining service life.

The service life correction value is preferably checked after being determined, so that it is higher than a minimum service life correction value and lower than a maximum service life correction value, i.e. is within predetermined limits. This prevents the occurrence of unrealistic values in the calculation of the service life correction value.

A brushless motor usually has a circuit board that is indicated schematically at 36 in FIG. 2, and because measurement in the motor (stator) itself would entail excessive cost for most applications, it is usual to measure (at 20) the temperature of an NTC (Negative Temperature Coefficient) resistor 22 on circuit board 36;

alternatively, for a fan, the temperature in the air flow of the fan, likewise using an NTC resistor 22′. Other temperature sensors 22, 22′ can, however, also be used, for example thermistors (e.g. platinum measuring resistors) or integrated semiconductor temperature sensors.

From these measured values, using a predetermined correlation or function, for example in the form of a correction table or a mathematical formula, an approximate temperature in the bearings can be determined. This can be expressed as follows:

T_L=f(T_S,n),

where T_L is the approximately determined temperature at the bearing, T_S the temperature at the sensor, and n the rotation speed. The function f either can be a mathematical formula, or the value T_L pertinent to the determined or measured values T_S, n can be read out from a correction table KT. Depending on the type of motor, it can be necessary to estimate the bearing temperature T_L using further parameters so that it agrees well with the actual bearing temperature.

This results, for example, in a correlation

T_L=f(T_S,n,I,U)

in which I is the current flowing through the motor and U is the voltage at the motor, usually referred to as the link circuit voltage. This is further explained later on.

What results for the service life in this case is

L10(T_L)=f(T_L)=f(T_S,n,I,U).

Experiments have shown that especially with high-output electric motors that have, for example, electrical outputs of 50 W, the temperature that is measured in the region of circuit board 36 associated with the motor can deviate considerably from the temperature at the bearings, since because of the high output and the large currents (e.g. 3 A) in the winding arrangement (despite the low ohmic resistance) of the electric motor, a higher temperature can occur locally at the site of the bearings. The measured temperature does characterize a temperature of the electric motor, but different temperatures can occur in different regions of the electric motor. Further experiments have shown that the temperature of the bearings, if it cannot be measured directly, is approximately dependent on the temperature measured at the circuit board and on the rotation speed of the electric motor, since a higher electric motor speed requires a higher motor output, with the result that more heat also occurs in the region of the bearings. In addition, at a higher rotation speed the friction in the ball bearings causes heating that results in an additional temperature elevation. Under laboratory conditions, a measurement can therefore be made in which various outside temperatures are established, and for each predetermined outside temperature, different rotation speeds are established and the temperature at the temperature sensor, and the temperatures at the bearings, are measured.

This yields an approximate value for the temperature at the bearings as a function of the temperature value measured by the temperature sensor and the rotation speed, and this approximate value can be used approximately for every electric motor that is identical in design to the electric motor examined under laboratory conditions. The following correlations (taken from the family of characteristic curves) can be generated, for example, as a result:

T_bearing(T_sensor=40° C., n=2000 min⁻¹)=42° C.

T_bearing(T_sensor=40° C., n=4000 min⁻¹)=45° C.

T_bearing(T_sensor=40° C., n=6000 min⁻¹)=51° C.

T_bearing(T_sensor=60° C., n=2000 min⁻¹)=62° C.

T_bearing(T_sensor=60° C., n=4000 min⁻¹)=67° C.

T_bearing(T_sensor=60° C., n=6000 min⁻¹)=72° C.,

where T_bearing corresponds to the temperature at the bearing, which depends on T_sensor (the temperature measured by temperature sensor 22, 22′) and on the rotation speed n.

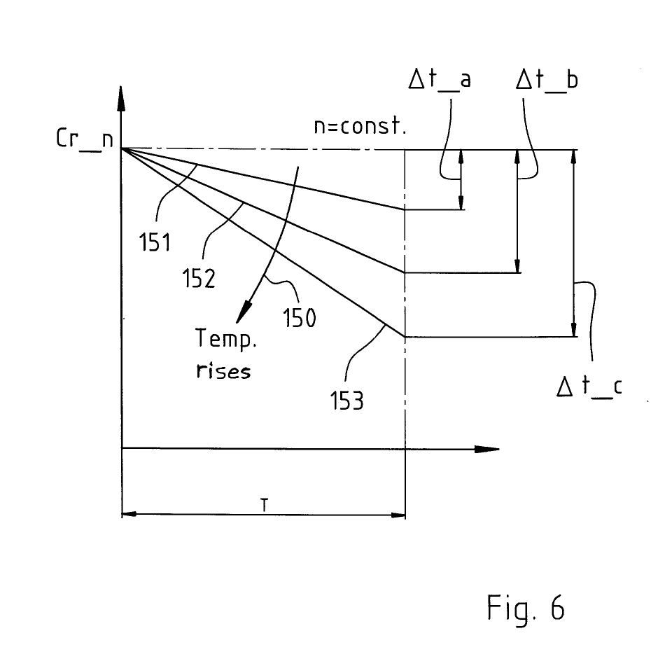

A measurement of this kind under laboratory conditions is also advantageous in terms of accounting for further effects. With many electric motors, for example, an air flow occurs during operation through the interior of the rotor, for example in FIG. 6 through bearing tube 184, through the region between rotor 171 and stator 176 to the open end of rotor cup 174, or vice versa. The effect is described in detail, for example, in published application WO 2012/130405 A1 and corresponding US 2013/323096-A, MUELLER et al., for an air flow between the open end of the fan wheel and openings in the fan wheel, and reference is made thereto. This air flow can reverse depending on the working point and can thus be entirely absent at certain working points, with the result that poorer cooling occurs at that point in the motor. Critical working points of this kind are determined by measuring the bearing temperature as a function of the temperature at the temperature sensor and the rotation speed, and the service life correction value is correspondingly increased.

It is also possible to arrange the circuit board associated with the electric motor outside the electric motor housing, so that the temperature sensor essentially measures the ambient temperature. In this case, the influence of rotation speed on the bearing temperature becomes even greater.

The measurement results can be stored in the electric motor as a family of characteristic curves (two-dimensional or multi-dimensional family with correlation values) so that an approximate value for the temperature can be determined from the family of characteristic curves respectively measured by the temperature sensor; or an approximation formula, with which the temperature at the bearings can be approximately calculated or determined, can be generated. If the rotation speed-dependent elevation in temperature at the bearings in the desired working region is largely independent of the current temperature, it is also possible to assume a temperature correction value that is dependent on rotation speed but not dependent on the temperature measured at the temperature sensor, and that temperature correction value is then added to the temperature measured by the temperature sensor in order to determine an approximate value for the temperature at the bearings.

The explanations show that there is no general relationship between the service life of the fan and the measured value T, n, etc., but instead that this correlation must be determined for each type of fan.

Because the temperature at the bearings is only indirectly relevant to service life and is usually not conveyed to the outside, it is also possible to directly associate with the electric motor a mathematical formula, or a family of characteristic curves, from which it can determine the service life correction value. Another possibility is to carry out, in the context of calculation from a family of characteristic curves, an interpolation between the closest predetermined points of the family of characteristic curves.

The result thereby obtained is the service life correction value, as a function of temperature, rotation speed, and optionally further values or parameters.

In a motor having several bearings, what can be used as a basis for determining the service life correction value is the temperature at that bearing at which the highest temperatures are measured in the laboratory test; or the different temperatures at the bearings measured in the laboratory tests can be averaged.

The rotation speed can preferably be used to decrease the service life correction value, for example to zero, when the electric motor is at a standstill. This is not necessary with many fans, however, for example, because they always rotate at a minimum speed when switched on.

The temperature measurement by means of NTC resistor 22 or 22′ yields a nonlinear characteristic curve between the temperature signal and the temperature, and this can be linearized, for example, in a module 236 with the aid of a correction table or a mathematical formula. Here the analog output values of NTC resistor 22 or 22′, or the temperature signal 33 generated as a function of temperature sensors 22, 22′ (FIG. 2), are digitized, and temperature values from a linear characteristic curve are assigned to the digitized values in order to simplify further processing of those values.

FIG. 2 shows one such arrangement:

On the right is a microprocessor (μP) 30 that usually also serves to control the commutation of brushless motor 32, as indicated by an arrow 34. Associated with this is an EEPROM 31 (see FIG. 1) or another nonvolatile memory, which serves to store instantaneous data for the available service life. A different calculation device 30, for example an ASIC (Application-Specific Integrated Circuit), can also be used instead of μP 30.

NTC resistor 22 (e.g. 47 kOhm), which is connected in series with a constant resistor 40 (e.g. 10 kOhm) between a constant voltage U_{B} of, for example, +5 V and ground 42, is located on circuit board 36. Connection 44 between resistors 22 and 40 is connected, via an RC element 46, 48 having a resistor 46 and a capacitor 48, to an A/D terminal 34 of μP 30, and the potential at connection 44, or temperature signal 33, is digitized in μP 30 via an A/D converter and then preferably linearized. Resistor 46 of the RC element has a value of, for example, 2.2 kOhm, and capacitor 48 has a value of, for example, 10 nF.

The rotation speed of motor 32 is sensed in module 240 (FIG. 1). There are various possibilities here, depending on the type of motor. If the motor has a rotor position sensor, e.g. a Hall sensor 43 or an Anisotropic Magneto-Resistive (AMR) sensor, the output signal of that sensor, whose frequency is proportional to the rotation speed of motor 32, can be used. The time span between two changes in the output signal, which is inversely proportional to the rotation speed, is also often used directly, since that time span is easy to measure. If motor 32 operates without a sensor, i.e. is “sensorless,” the corresponding “substitute Hall” signal of the motor can be used, for example in the form of the counter-EMF of the motor, or a digitized value of the motor current. The rotation speed signal can preferably be conditioned in a module 244, for example by linearization.

Bearing-dependent constants can be adjusted in a module 51. These preferably depend principally on the nature of the bearing (i.e. plain or ball bearing), on the bearing lubrication grease used, on the properties of the axial bearing biasing (e.g. using a spring or magnetic attraction), and on the radial load that results, for example, from the imbalance of the impeller of a fan and on the correlation between the motor temperature and service life. These values can be combined in μP 30 with the temperature values from temperature sensor 20 if a more accurate forecast of the prospectively still remaining life expectancy is desired.

In module 60, at least one fan-dependent constant is preferably inputted. This is usually the L10 value, for example at 20° C. and optionally at a specific rotation speed, which can be taken from manufacturers' catalogs, i.e. for example L10=60,000 hours.

In module 70, preferably working-point-dependent correction data, which have resulted from long-term experiments for the relevant motor type and evaluation thereof, can be inputted. Comprehensive measured data and other empirical values, which are often based on years of measurements and therefore enable a more accurate forecast, are available from the manufacturer for many types of motor.

Environmental influences, i.e. principally dust and moisture, can preferably be taken into consideration in module 80. With clean air, a maximum life expectancy of L10*1.0 can be used, and for highly contaminated or very moist air, for example, a life expectancy of only L10*0.7. In many cases these factors can be input as fixed values, for example when the fans are used in a spinning mill. In other cases, for example in vehicles, a module 82 can be used in which the dust density is measured, so that, for example, a prospective life expectancy of L10*0.7 can be utilized in a desert, but a life expectancy of L10*1.0 in a region with clean air.

From the values (parameters) enumerated, the life expectancy still available is calculated in μP 30, i.e., for example, the remaining value L10 at the present time, or a customer-specific value L(x), for example L1 or L5, or the number of hours of service life still (theoretically) available, or the number of hours already used up. The calculated value is preferably based on measured values, and is therefore a good reflection of the prospectively remaining life expectancy of the relevant motor 32. The calculated values are outputted in an output apparatus 83, e.g. as a digital display value, or as a signal that can be transferred to a central display or a central monitoring system so that several motors or fans can be monitored simultaneously.

One or more leads 84 enable the input of signals to μP 30, for example, a target rotation speed signal or an external temperature signal or moisture signal.

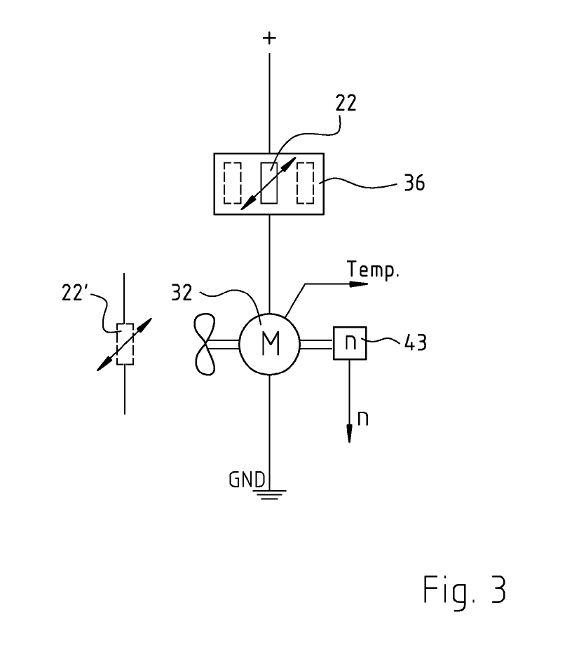

FIG. 3 shows motor 32 with two sensors 22, 22′ for measuring temperature; depending on the desired accuracy, the two sensors 22, 22′ can be used alternatively or cumulatively. Sensors 22, 22′ can each be arranged on a circuit board 36. A Temp. signal 33 (see FIG. 2) is generated and outputted, and a rotation speed signal that characterizes the rotation speed of motor 32 is generated via a rotor position sensor 43.

### Working Principle

It is assumed that a new motor or fan has an optimum working point, e.g. operation at a constant temperature of 20° C. and a constant rotation speed of 2000 rpm, at which the expected service life is longest, e.g. 65,000 hours.

This value is usefully multiplied by a factor, i.e. for example 4 times 65,000. This yields an “initial balance” of 260,000 credit points as an indication of the service life yet to be expected at a predetermined working point, the predetermined working point preferably corresponding to a working point under good conditions, for example at a low temperature.

This initial balance is deposited, i.e. stored, in EEPROM (Electrically-Erasable Programmable Read-Only Memory) 31 (FIG. 1) or in another nonvolatile memory. This is usually done by the manufacturer in order to prevent manipulations of the expected service life value.

During operation, the temperature and rotation speed are measured at predetermined intervals (e.g. every 80 seconds=45 times per hour). A service life correction value Δt_n+1 for the relevant point in time n+1 is thereby calculated, e.g. Δt=0.05 credit points at high temperature and high rotation speed. This is then the value by which the previous value Cr_n has decreased within those 80 seconds for those specific values.

This correction value is subtracted from the balance Cr_n (from the previous measurement), yielding a reduced balance Cr_n+1. If the successive balances are referred to as Cr_n and Cr_n+1, what results is the formula

Cr_n+1=Cr_n−Δt_n+1 (1)

After each decrease in the balance Cr, a check can take place as to whether it is still sufficiently large.

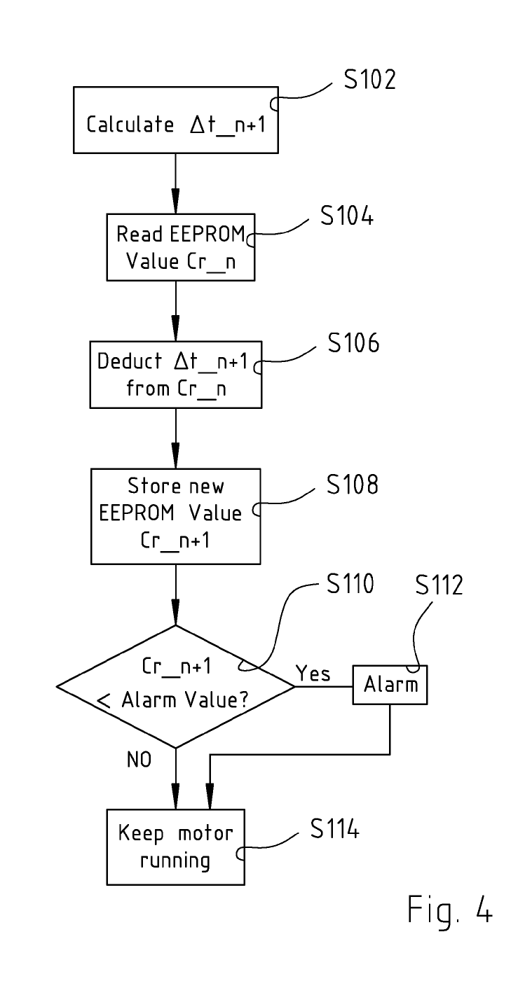

FIG. 4 shows this procedure in a pseudo-programming language that is understandable to one having ordinary skill in the art. In step S102, a correction value Δt_n+1 is calculated from the measured values, i.e. principally the temperature and rotation speed of motor 32.

In step S104, the instantaneous balance Cr_n is read out from EEPROM 31.

In step S106, the calculated correction value Δt_n+1 is subtracted from this value Cr_n, and in S108 the result, i.e. Cr_n+1, is again stored in EEPROM 31, where it replaces the previous value Cr_n.

Step S110 checks whether the instantaneous “balance” Cr_n+1 has dropped below a permissible limit balance at which, for example, an alarm (or pre-alarm) is triggered. If so, an alarm signal is generated at S112. If the response at S110 is No, motor 32 continues to run without change at S114, and the measurements are continued, i.e. the sequence according to FIG. 4 repeats, if applicable for years, at predetermined time intervals T, in order to produce an up-to-date picture of the remaining service life of the motor or of fan 32.

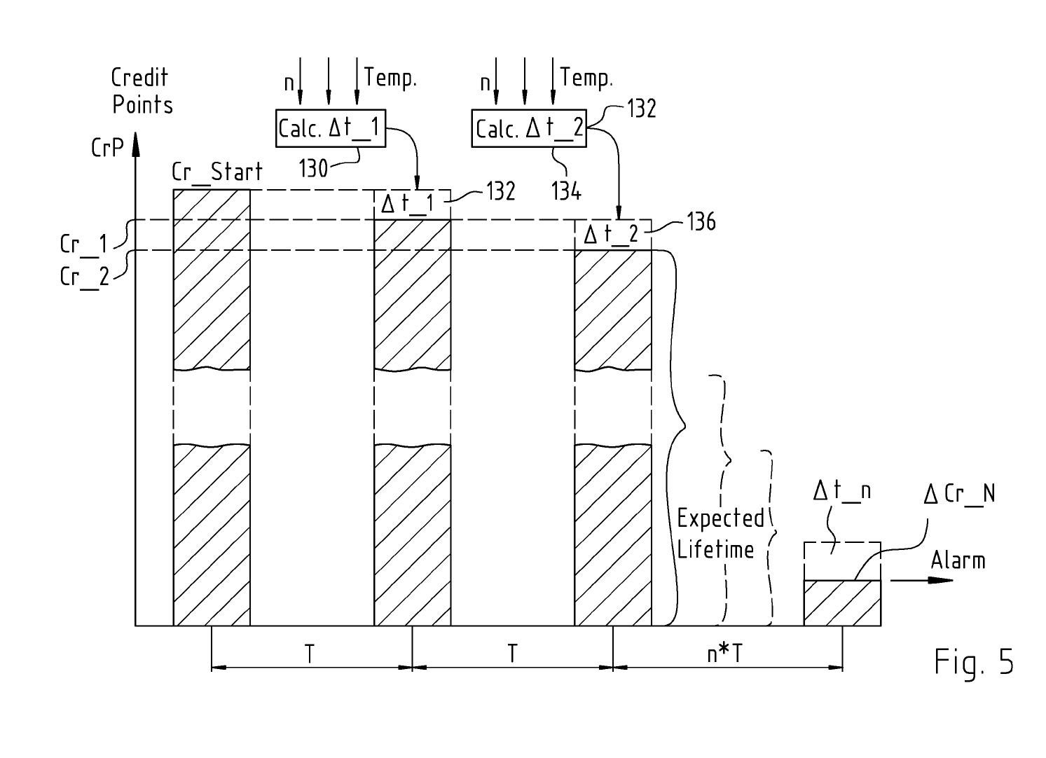

FIG. 5 is an explanatory diagram. The ordinate CrP shows the respective running time reserve that continuously decreases over time when motor 32 is running, principally because the bearings of motor 32 are subject to wear, which is mostly a function of motor rotation speed n and motor temperature.

This running time reserve is at its highest value Cr_Start for a new motor and can be indicated, as explained in the example, as credit points CrP.

After it is switched on, the rotation speed n and temperature of motor 32 are measured during time span T1, and the correction value Δt_1, i.e. the length of time by which the running time reserve Cr_Start has decreased during the time T1, is thereby calculated at 130. The value Δt_1 is therefore subtracted from Cr_Start at 132, and the result is stored in EEPROM 31 at S108 (FIG. 4).

Once time span T1, which can be, for example, 80 seconds, has elapsed, the rotation speed n and temperature are measured again and at 134 the correction value Δt_2 is calculated therefrom. This value is then, at 136, subtracted from the value Cr_1 stored in EEPROM 31, producing a new, lower value Cr_2. This means that the expected service life of motor 32 has become shorter.

Ultimately, i.e. perhaps several years later, the value Cr_N in the EEPROM has become sufficiently low that ultimately, in the test in step S110 of FIG. 4, an alarm or pre-alarm is triggered as a reminder to replace the motor. This usually occurs earlier in time than the calculated “statistical” end-of-life of motor 32, so that replacement is possible without difficulty.

FIG. 6 shows the determination of Δt at constant rotation speed and variable temperature.

When the temperature is low, e.g. 25° C., a low value Δt_a results.

At a moderately high temperature, e.g. 55° C., a higher correction value Δt_b results.

At a high motor temperature, e.g. 100° C., a high correction value Δt_c results.

Of course only very low correction values are produced within 80 seconds; they represent a mathematical picture of the profile of the remaining service life, but would themselves be measurable only indirectly and at high cost.

Depending on the application, either only one alarm signal can be transferred when the calculated service life is shorter than a predetermined service life, or a service life signal can be outputted upon request, or at regular time intervals, or when a predetermined condition exists, such as expiration of a predetermined partial service life.

Transfer of the service life signal and/or alarm signal from the motor to a display or control apparatus can occur in wire-based or non-wire-based fashion, for example via an IR or radio connection. The latter variants are advantageous when it is cumbersome to run a cable from the motor to a control apparatus.

It is possible to transfer the alarm signal or service life signal via a PWM signal having a pulse duty factor pwm; for example

pwm=100%=full service life;

pwm=7%: only 7% service life available.

The alarm signal or service life signal can also be transferred via a signal in which, for example, the time span of a High signal between two Low signals is proportional to the consumed, or alternatively the remaining, service life; for example, a 1 μs time span of the High signal corresponds to one day of service life.

The alarm signal or service life signal can also be transferred in analog fashion, either as a percentage indication or as an absolute indication.

For a percentage indication it is specified, for example, that

5 V=full service life; and

1 V=20% service life,

i.e. a linear correlation.

For an absolute indication it is specified, for example, that

5 V=50,000 hours of service life;

0.5 V=5,000 hours of service life.

Alternatively, the correlations can be as follows:

5 V=at least 10,000 hours of service life;

2.5 V=5,000 hours of service life;

0.5 V=1,000 hours of service life.

This allows high resolution at the end of the service life.

Transfer via a digital signal (wire-based or non-wire-based) is also possible, a simple digital signal, where High=alarm and Low=no alarm, being possible for the alarm signal. For the service life signal or when multiple motors are being monitored, however, a protocol-based transfer of further information via a bus is advantageous, e.g. CAN bus, LEAN bus, IIC bus, etc.; see 83 in FIG. 1.

For a motor 32 having a control input and an output, it can be specified, preferably via the control input, whether the motor outputs the service life signal or the alarm signal at the output. For a motor to which the target rotation speed is conveyed via a PWM (Pulse Width Modulation) pulse duty factor, for example, a predetermined sequence of the pulse duty factor can stipulate whether the service life signal or the alarm signal is to be outputted. For example, if a PWM signal having a pulse duty factor of 70%, 30%, 80%, 20%, 100%, 0% is outputted via the control input, for a time span of 1 s in each case, motor 32 outputs the service life signal. Conversely, if, for example, a PWM signal having a pulse duty factor of 70%, 30%, 80%, 20%, 100%, 50% is outputted via the control input, for a time span of 1 s in each case, the alarm signal is then outputted.

The expected service life can be indicated either in analog fashion (e.g. analog pointer) or digitally (e.g. digital panel). The resolution of the indication can furthermore be increased at the end of the service life, although it must always be remembered that the values indicated have a large spread, and can be much higher or lower in individual cases.

In order to prevent the occurrence of errors if motor 32 is switched off during the operation in which EEPROM 31 is being written to, the calculated value Cr is stored in duplicate in each case, and multiple preceding Cr values are also stored in each case in EEPROM 31, so that a missing or incorrect value can easily be reconstructed.

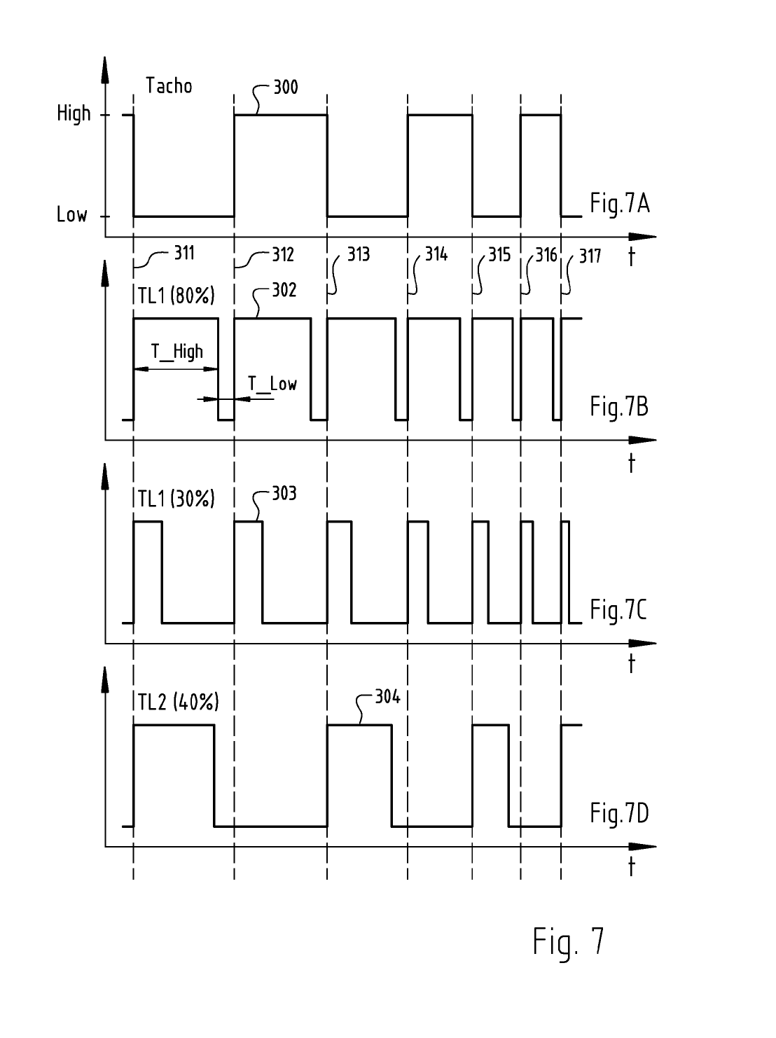

FIG. 7A shows a Tacho signal 300 whose frequency is proportional to the rotation speed of motor 32. For this, for example in the case of a single-phase motor, the signal of a rotor position sensor is outputted; or in the case of a three-phase motor the signal of one of the rotor position sensors or a combination of the signals of the rotor position sensors. Depending on the number of rotor poles and rotor position sensors, signal 300 has, for example, four changes per revolution or 12 changes per revolution. Signal 300 has a respective change from High to Low or Low to High at points 311, 312, 313, 314, 315, 316, 317. The frequency of signal 300 increases over time t, and this indicates that an acceleration is currently occurring.

FIG. 7B shows a TL1 signal 302 that represents a combination of the Tacho signal 300 with a service life signal. The service life signal is therefore modulated onto signal 300.

In TL1 signal 302 the remaining service life is 80%; signal 302 is therefore set from Low to High between each of the changes of signal 300 at points 311 to 317, and after approx. 80% of the time between two adjacent changes of signal 300 at points 311 to 317, TL1 signal 302 changes from High to Low and remains Low until the next change in signal 300. The time span between the current changes in signal 300 can be estimated on the basis of the preceding time span. For example, it can be assumed that the time span between the changes of signal 300 at points 312 and 313 corresponds approximately to the time span between times 311 and 312. This method performs well at least when the predetermined rotation speed is reached.

FIG. 7C shows TL1 signal 303 for a motor having a remaining service life of 30%, and signal 303 is correspondingly High for a shorter time between two of times 311 to 317 than in FIG. 7B.

Similarly, of course, signal 302 or 303 could first be set to Low between each two of times 311 to 317 and only then change to High. A nonlinear relationship can also be selected between the value for the service life and the ratio between the time span for High and the time span for High and Low, for example selecting a higher resolution in the region of shorter service life.

For both signals 302, 303, the rotation speed of the electric motor can be determined via the frequency of signals 302, 303, which corresponds to twice the frequency of signal 300. The remaining service life can be determined from the ratio T_High/T_Low, or from the ratio T_High/(T_High+T_Low) or T-Low/T_High+T_Low).

FIG. 7D shows a TL2 signal that again represents a combination of the Tacho signal 300 with a service life signal. With the TL2 signal as well, the time within a period during which the TL2 signal is High is determined as a function of the remaining service life. Here, however, a period extends in each case over two changes of signal 300, i.e. here between 311 and 313, between 313 and 315, and between 315 and 317, i.e. always between two trailing edges of signal 300. This has the advantage that TL2 signal 304 has the same frequency as signal 300, so that an external device that evaluates only the frequency of a Tacho signal 300 can also evaluate signal 304.

In summary, FIG. 7 refers to a digital signal having a value inventory that encompasses a first signal value (High or Low) and a second signal value (Low or High), the frequency of the signal being proportional to the rotation speed of the electric motor, and the ratio of the time span during which the signal has the first signal value to the time span during which the signal has the second signal value being a function of the service life value.

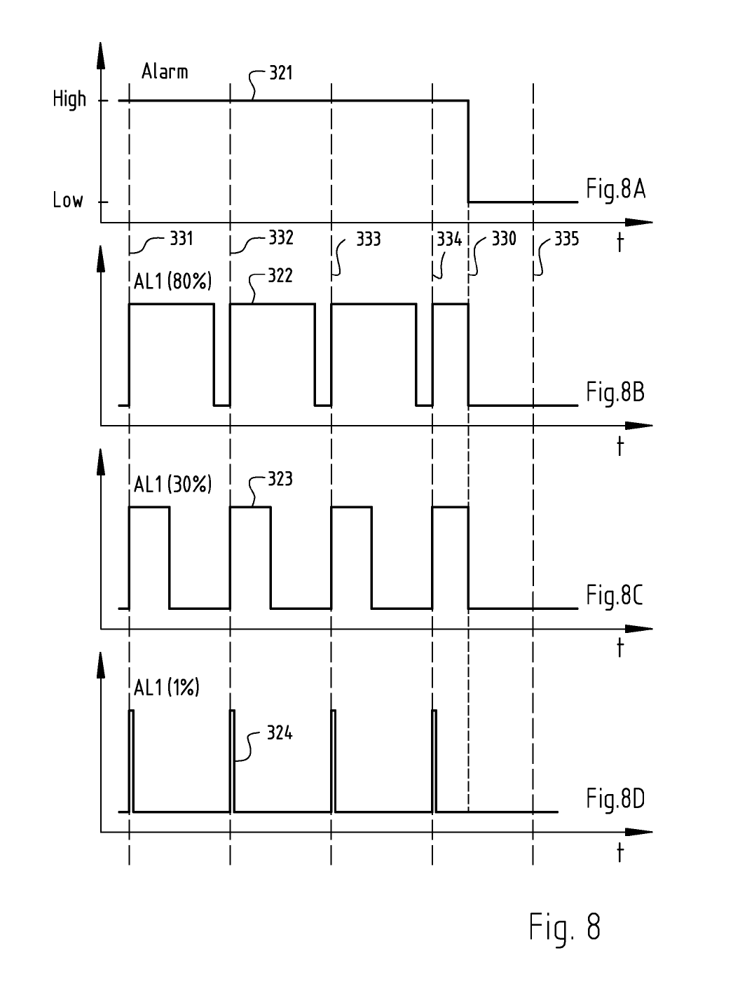

FIG. 8A shows an Alarm signal 321 as used in existing fans. The Alarm signal 321 has a High value as long as the motor does not detect a fault. If the motor does detect a fault, however, for example a stoppage of the motor, an overcurrent, or an insufficient rotation speed, Alarm signal 321 changes at a time 330 to Low in order to inform an external evaluation device that a fault is present in the motor. This can also be referred to as a “normal state” and “fault state.”

FIG. 8B shows an AL1 signal 322 in which the remaining service life of the motor has been modulated onto the Alarm signal 321. For this, the value of the remaining service life is outputted in the form of a PWM signal having a fixed frequency, such that, for example, the pulse duty factor corresponds to the value for the remaining service life; nonlinear correlations are also always possible. At point 330 at which the electric motor has detected a fault, AL1 signal 322 is set permanently to Low in order to inform an external evaluation device that a fault is present in the motor.

FIG. 8C shows AL1 signal 323 for a remaining service life of 30%, and FIG. 8D shows an AL1 signal 324 for a remaining service life of 1%, which means, for example, that the motor has already run sufficiently long that the probability of a failure is 10%. The pulse duty factor of signal 322, 323, 324 must not, however, be set to 0% unless a fault exists, since 0% corresponds to detection of a fault.

In summary, it can be stated that for the AL1 signal of FIG. 8: in a first state in which the electric motor has not detected a fault, the AL1 signal is outputted at a fixed frequency, the ratio of the time span during which the signal has the first signal value to the time span during which the signal has the second signal value being a function of the remaining service life value; and in a second state in which the electric motor has detected a fault, the signal is permanently set to Low until, for example, the electric motor is restarted.

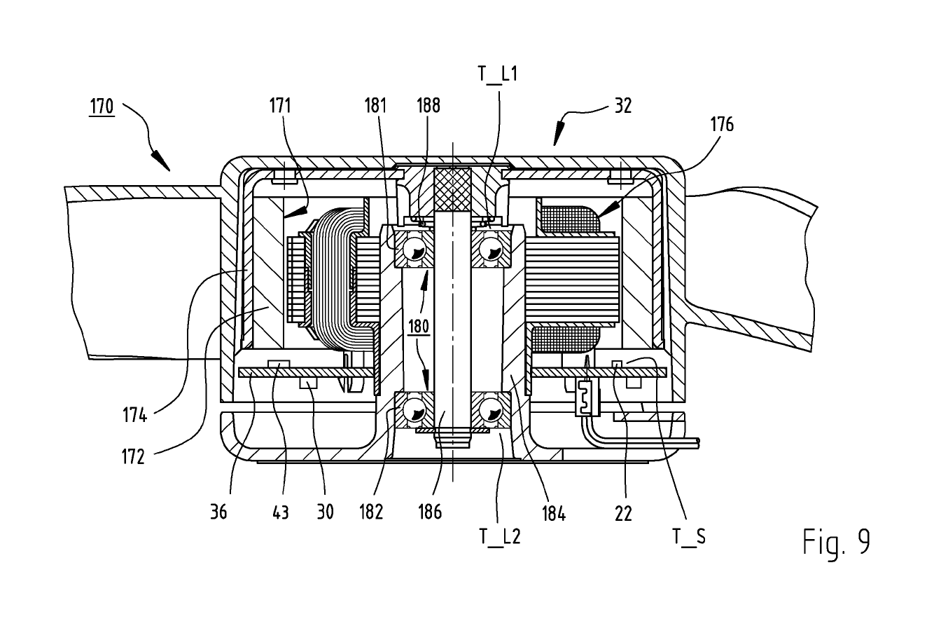

FIG. 9 shows the configuration of a preferred embodiment of electronically commutated motor 32. Motor 32 drives a fan having a fan wheel 170.

Motor 32 has a rotor 171 and a stator 176. Rotor 171 has a rotor magnet 172, a rotor cup 174, and a shaft 186. Stator 176 has a stator core and a winding arrangement, the current flowing during operation through the winding arrangement or through motor 32 generating a magnetic flux that, for example, drives the rotor.

Stator 176 is arranged, for example, on a bearing tube 184, and bearing tube 184 carries a bearing arrangement 180 that in this exemplifying embodiment encompasses a first bearing 181 and a second bearing 182 and is implemented to rotatably journal rotor 171.

A spring 188 is preferably provided in order to effect tensioning of the bearing arrangement.

Circuit board 36 is arranged in motor 32, and it is preferably arranged on bearing tube 184 if one is present.

Rotor position sensor 43, microprocessor 30, and temperature sensor 22 are provided on circuit board 36.

The temperature at bearing 181 is designated T_L1, the temperature at bearing 182 T_L2, and the temperature at temperature sensor 22 T_S. During development, temperature sensors can be provided for research purposes in the region of bearings 181, 182 in order to determine temperatures T_L1 and T_L2 as a function of temperature T_S and the rotation speed n of motor 32, i.e. to establish a correlation among these values. Thanks to the use of the arrangement according to the present invention for determining a service life correction value, the temperature sensors at bearings 181, 182 can then be omitted from the series-produced product, and a good estimate of the service life can nevertheless be made.

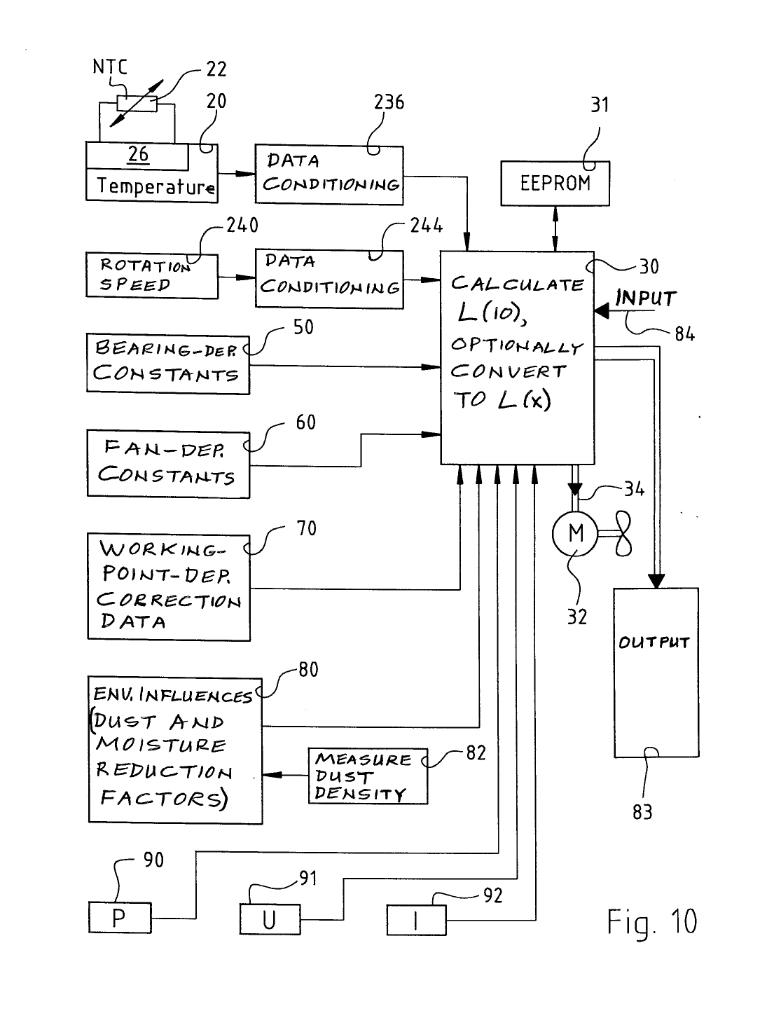

FIG. 10 shows motor 32 having μP 30 for determining a value for the prospectively still available service life. The configuration and function correspond in principle to the configuration and principle of FIG. 1.

In addition, however, an arrangement 90, an arrangement 91, and an arrangement 92, which are connected to μP 30, are provided.

Arrangement 90 is labeled P and it serves to sense a value, which value characterizes the electrical power consumed by motor 32.

Arrangement 91 is labeled U and it serves to sense a value, which value characterizes the electrical voltage delivered to motor 32.

Arrangement 92 is labeled I and it serves to sense a value, which value characterizes the electrical current flowing through motor 32.

The determination of power P by means of an arrangement 90, the determination of the electrical voltage U delivered to motor 32, and the determination of the current flowing through motor 32 are described in detail in published application WO 2013/020689 A1, to which reference is made.

Experiments have indicated that in motors 32 in which an air flow flows through motor 32 and in which, as described above, at certain working points a reversal of the air flow takes place, an extreme temperature elevation can occur because of the poor cooling of motor 32 at those operating points; in experiments with high-output motors 32, temperature elevations of 40 K with respect to ambient temperature have occurred. In high-output motors of this kind having a reversal of the air flowing through motor 32, it has been found that it is difficult to ascertain, on the basis of temperature and rotation speed, the exact working point at which this reversal takes place. The working point of the fan can be ascertained considerably better, however, by way of the electrical power consumed by the fan, and with fans that exhibit such special features it is therefore advantageous to provide an arrangement 90 for sensing electrical power, and/or arrangements 91, 92 for sensing voltage and current.

When examining the fan in the laboratory, for example, it is possible to measure the temperature at sensor 22, the temperature at the bearing, the rotation speed n, and either the electrical power or the voltage and current; and as a function thereof in the various operating states or at the various operating points of the fan, a correlation can be calculated or determined between the temperature at the bearing and the other measured values.

Experiments have shown that for certain motors, the determination of the service life correction value can be considerably improved, whereas for other motors it is sufficient to consider the measured temperature and the rotation speed.

In the measurement of voltage U and current I, the power P can be calculated as an intermediate step. Alternatively, the values U and I can also be used directly to calculate the service life correction value.

Many variants and modifications are of course possible in the context of the present invention.

The figures and the description show an electronically commutated motor 32 with which is associated a circuit board 36 having arranged thereon a temperature sensor 22 for generating a temperature signal, and having a first arrangement for continuous determination of the prospectively still available service life of motor 32, which first arrangement comprises:

a second arrangement 20, 236 for sensing a first value that is dependent on temperature signal 33 and that characterizes the temperature T_S in the region of circuit board 36;

a third arrangement 240; 244 for sensing a second value that characterizes the rotation speed n of motor 32;

a memory 31 for storing a digital third value Cr for the prospectively still available service life of motor 32;

a calculation apparatus 30 and an output apparatus 83 for outputting at least one first signal, which first arrangement is implemented to:
generate at time intervals a current service life correction value Δt that is dependent on the sensed first value for the temperature and the sensed second value for the rotation speed n,
modify the presently stored third value for the prospectively still available service life Cr, as a function of the calculated current service life correction value Δt,
store the result in the memory as a new presently stored third value for the still available service life Cr, and
generate the first signal as a function of the stored third value, and output it.

According to a preferred embodiment, the motor comprises a bearing, and the current service life correction value Δt is generated in such a way that the third value Cr for the prospectively still available service life of motor 32 corresponds approximately to the still available service life of the bearing.

According to a preferred embodiment, the motor comprises ball bearings. This has the advantage that the temperature-dependent determination of the service life correction value leads to good results.

According to a preferred embodiment, the first arrangement is implemented to monitor the stored third value and to generate and output the first signal at least when the stored third value reaches a predetermined limit value that is associated with an imminent expiration of the prospectively still available service life Cr.

According to a preferred embodiment, when the motor is new, in the first arrangement a value Cr_Start of the expected service life under predetermined operating conditions is assumed as a third value for the available service life.

According to a preferred embodiment, the third value indicates an increasingly short service life with ongoing use of the fan, and an increase in the indicated service life is excluded. The wear that constantly occurs is thereby taken into account.

According to a preferred embodiment, the motor is implemented to control commutation during operation by way of a microprocessor 30.

According to a preferred embodiment, microprocessor 30 also serves as a calculation apparatus for calculations that ensue in the context of determining the prospectively still available service life Cr and the service life correction value Δt.

According to a preferred embodiment, microprocessor 30 is arranged on circuit board 36 with temperature sensor 22, 22′.

According to a preferred embodiment, at least some of the digital values in nonvolatile memory 31 are stored several times in order to achieve greater security in terms of data loss.

According to a preferred embodiment, calculation apparatus 30 is implemented to generate an alarm signal if the calculated third value of the prospective service life exceeds or falls below a predetermined limit value.

According to a preferred embodiment, the first arrangement is implemented to generate the service life correction value Δt at regular time intervals T.

According to a preferred embodiment, the first arrangement is implemented to generate the service life correction value Δt less than 100 times per hour.

According to a preferred embodiment, calculation apparatus 30 is implemented to output via output apparatus 83, as a function of the third value Cr for the prospectively still available service life of electric motor 32, a service life signal that characterizes the third value Cr.

According to a preferred embodiment, the service life signal is outputted in the form of a PWM signal whose pulse duty factor pwm is dependent on the third value Cr.

According to a preferred embodiment, the motor is implemented to output via output apparatus 83 either an alarm signal or a service life signal, the alarm signal indicating that the calculated third value of the prospective service life exceeds or falls below a predetermined limit value, in which a target rotation speed signal for specifying a target rotation speed is deliverable via a lead 84 to calculation apparatus 30, and in which for a predetermined time course of the target rotation speed signal a change from output of the service life signal to output of the alarm signal, or vice versa, takes place.

According to a preferred embodiment, the rotation speed signal is a PWM signal.

According to a preferred embodiment, the motor is implemented to output via output apparatus 83 either an actual rotation speed signal or a service life signal, the actual rotation speed signal indicating the magnitude of the current rotation speed of the electric motor, and a target rotation speed signal for specifying a target rotation speed is deliverable via a lead 84 to calculation apparatus 30, and for a predetermined time course of the target rotation speed signal, a change from output of the service life signal to output of the actual rotation speed signal, or vice versa, takes place.

According to a preferred embodiment, output apparatus 83 makes possible non-wire-based output of the service life signal.

According to a preferred embodiment, the first arrangement comprises an apparatus 82 for measuring a value characterizing the dust density, and in which generation of the current service life correction value Δt is also dependent on the value characterizing the dust density.

According to a preferred embodiment, the first arrangement comprises an apparatus 80 for measuring a value characterizing the moisture in the environment of fan 30, and in which generation of the current service life correction value Δt is also dependent on the aforementioned value characterizing the moisture.

According to a preferred embodiment, the first arrangement is implemented to generate the first signal as a digital signal having a value inventory that encompasses a first signal value (High or Low) and a second signal value (Low or High), the frequency of the first signal being proportional to the rotation speed of the electric motor, and the ratio of the time span during which the first signal has the first signal value to the time span during which the first signal has the second signal value being a function of the third value.

According to a preferred embodiment, the first arrangement exhibits a first state in which no fault of the electric motor has been detected, and exhibits a second state in which a fault of the electric motor has been detected, and the first arrangement is configured to generate the first signal as a digital signal having a value inventory that encompasses a first signal value (High or Low) and a second signal value (Low or High), in the first state of the first arrangement, the first signal being outputted at a fixed frequency, the ratio of the time span during which the first signal has the first signal value to the time span during which the first signal has the second signal value being a function of the third value, and in the second state of the first arrangement the first signal exhibiting only the first signal value.

According to a preferred embodiment, the memory is a nonvolatile memory 31.

According to a preferred embodiment, the first arrangement comprises a fourth arrangement 90 for sensing a fourth value, which fourth value characterizes the electric power consumed by motor 32, the first arrangement being implemented to generate the current service life correction value Δt as a function of the sensed first value for the temperature, the sensed second value for the rotation speed n, and the fourth value.

According to a preferred embodiment, the first arrangement comprises a fifth arrangement 91 for sensing a fifth value, which fifth value characterizes the electrical voltage delivered to motor 32, in which the first arrangement comprises a sixth arrangement 92 for sensing a sixth value, which sixth value characterizes the electrical current flowing through motor 32, the first arrangement being implemented to generate the current service life correction value Δt as a function of the sensed first value for the temperature, the sensed second value for the rotation speed n, the fifth value, and the sixth value.

1. An electronically commutated motor (32) with which is associated a circuit board (36) having arranged thereon a temperature sensor for generating a temperature signal,
and having a first arrangement for continuous determination of the prospectively still available service life of the motor (32),
which first arrangement comprises:
a second arrangement (20, 236) for sensing a first value that is dependent on the temperature signal (33) and that characterizes the temperature (T_S) in the region of the circuit board (36);
a third arrangement (240; 244) for sensing a second value that characterizes the rotation speed (n) of the motor (32);
a memory (31) for storing a digital third value (Cr) for the prospectively still available service life of the motor (32);
a calculation apparatus (30) and an output apparatus (83) for outputting at least one first signal,
which first arrangement is implemented to:
generate at time intervals a current service life correction value (Δt) that is dependent on the sensed first value for the temperature and the sensed second value for the rotation speed (n),
modify the presently stored third value for the prospectively still available service life (Cr), as a function of the calculated current service life correction value (Δt),
store the result in the memory as a new presently stored third value for the still available service life (Cr), and
generate the first signal as a function of the stored third value, and output it.

2. The motor according to claim 1, in which the first arrangement is configured to monitor the stored third value and to generate and output the first signal, at least when the stored third value reaches a predetermined limit value that is associated with an imminent expiration of the prospectively still available service life (Cr).

3. The motor according to claim 1, in which when the motor is new, in the first arrangement a value (Cr_Start) of the expected service life under predetermined operating conditions is assumed as a third value for the available service life.

4. The motor according to claim 1, wherein commutation steps are carried out under control of a microprocessor (30).

5. The motor according to claim 4, in which the microprocessor (30) also serves as a calculation apparatus for calculations that ensue in the context of determining the prospectively still available service life (Cr) and the service life correction value (Δt).

6. The motor according to claim 4, in which the microprocessor (30) is arranged on the circuit board (36) with the temperature sensor (22, 22′).

7. The motor according to claim 6, in which at least some of the digital values in the nonvolatile memory (31) are stored several times at respective locations in order to achieve greater security in terms of data loss.

8. The motor according to claim 5, in which the calculation apparatus (30) is configured to generate an alarm signal if the calculated third value of the prospective service life deviates by at least a predetermined amount from a predetermined limit value.

9. The motor according to claim 5, in which the first arrangement is implemented to generate the service life correction value (Δt) at regular time intervals (T).

10. The motor according to claim 5, in which the first arrangement is implemented to generate the service life correction value (Δt) less than 100 times per hour.

11. The motor according to claim 5, in which the calculation apparatus (30) is implemented to output via the output apparatus (83), as a function of the third value (Cr) for the prospectively still available service life of the electric motor (32), a service life signal that characterizes the third value (Cr).

12. The motor according to claim 11, in which the service life signal is outputted in the form of a pulse width modulation signal whose pulse duty factor (pwm) is dependent on the third value (Cr).

13. The motor according to claim 11, which is implemented to output via the output apparatus (83) either an alarm signal or a service life signal, the alarm signal indicating that the calculated third value of the prospective service life deviates by at least a predetermined amount from a predetermined limit value,
in which a target rotation speed signal for specifying a target rotation speed is deliverable via a lead (84) to the calculation apparatus (30), and
in which, for a predetermined time course of the target rotation speed signal, a change from output of the service life signal to output of the alarm signal, or vice versa, takes place.

14. The motor according to claim 13, in which the rotation speed signal is a pulse width modulation signal.

15. The motor according to claim 11, which is configured to output via the output apparatus (83) either an actual rotation speed signal or a service life signal, the actual rotation speed signal indicating the magnitude of the current rotation speed of the electric motor,
in which a target rotation speed signal for specifying a target rotation speed is deliverable via a lead (84) to the calculation apparatus (30), and in which, for a predetermined time course of the target rotation speed signal, a change from output of the service life signal to output of the actual rotation speed signal, or vice versa, takes place.

16. The motor according to claim 11, in which the output apparatus (83) further comprises means for non-wire-based output of the service life signal.

17. The motor according to claim 1, in which the first arrangement comprises an apparatus (82) for measuring a value characterizing a density of dust, and in which generation of the current service life correction value (Δt) is also dependent on said dust density value.

18. The motor according to claim 1, in which the first arrangement further comprises an apparatus (80) for measuring a value characterizing ambient moisture near said fan (30), and in which generation of the current service life correction value (Δt) is also dependent on the value characterizing the ambient moisture.

19. The motor according to claim 1, in which the first arrangement is implemented to generate the first signal as a digital signal having a value inventory that encompasses a first signal value (High or Low) and a second signal value (Low or High),
the frequency of the first signal being proportional to the rotation speed of the electric motor,
and the ratio of the time span during which the first signal has the first signal value to the time span during which the first signal has the second signal value being a function of the third value.

20. The motor according to claim 1,
in which the first arrangement exhibits a first state in which no fault of the electric motor has been detected, and which exhibits a second state in which a fault of the electric motor has been detected, and which first arrangement is configured to generate the first signal as a digital signal having a value inventory that encompasses a first signal value (High or Low) and a second signal value (Low or High),
in the first state of the first arrangement, the first signal being outputted at a fixed frequency, the ratio of the time span during which the first signal has the first signal value to the time span during which the first signal has the second signal value being a function of the third value, and in the second state of the first arrangement, the first signal exhibiting only the first signal value.

21. The motor according to claim 1, in which the memory is a nonvolatile memory (31).

22. The motor according to claim 1,
in which the first arrangement comprises a fourth arrangement (90) for sensing a fourth value, which fourth value characterizes electrical power consumed by the motor (32), and
the first arrangement is configured to generate the current service life correction value (Δt) as a function of the sensed first value for the temperature, the sensed second value for the rotation speed (n), and the fourth value.

23. The motor according to claim 1,
in which the first arrangement comprises a fifth arrangement (91) for sensing a fifth value, which fifth value characterizes the electrical voltage delivered to the motor (32),
in which the first arrangement comprises a sixth arrangement (92) for sensing a sixth value, which sixth value characterizes the electrical current flowing through the motor (32),
the first arrangement being implemented to generate the current service life correction value (Δt) as a function of the sensed first value for the temperature, the sensed second value for the rotation speed (n), the fifth value, and the sixth value.
